(19) United States
(12) Patent Application Publication
(10) Pub. No.: US 2004/0192273 A1
(43) Pub. Date: Sep. 30, 2004

(54) Speed answers to voice prompts

(76) Inventor: Al T. AuYeung, Lake Oswego, WA (US)

Correspondence Address: Al T. AuYeung, 17485 Brookhurst Dr., Lake Oswego, OR, 97034, US

(21) Appl. No.: 10/336,180

(22) Filed: Jan. 2, 2003

(51) Int. Cl. H04Q 7/20; H04M 11/00; H04M 3/42

(52) U.S. Cl. 455/414.3; 455/403

(57) ABSTRACT

A communication apparatus is equipped to enable a user to quickly answer a voice prompt during a call with a callee. In one embodiment, the apparatus is equipped to enable the user to select one of a number of pre-stored potential voice prompt answers as a current selected potential voice prompt answer, and send the current selected potential voice prompt answer as a voice prompt answer to the voice prompt of the callee during the call. In one embodiment, the apparatus is equipped to track its operational state, which includes a non-call-in-progress state and a call-in-progress state. Further, the apparatus is equipped to respond to a user input, in particular, a scroll and a dial/send input in a state dependent manner, to effectuate the selection and sending of voice prompt answers. In one embodiment, the apparatus is a wireless mobile phone.

### BACKGROUND OF THE INVENTION

1. Field of the Invention

The present invention relates to the fields of telephony and data processing. More specifically, the present invention relates to the provision of answers to voice prompts for telephony and/or data processing applications.

2. Background Information

Advances in integrated circuit, microprocessor, networking, and telecommunication technologies have led to great improvements in the functionalities and features of telephony and data processing.

For example, most telephone users, whether it is for business or personal purposes, have voice mailboxes, with which callers may leave voice messages for the users, in the event the users are unable to answer the calls at the time of the calls. Further, most voice mailboxes support remote retrieval of the voice messages. The process typically involves the user calling the telephone number of a voice messaging service, providing a voice mailbox identifier, providing a password for the voice mailbox, and then one or more menu selections (e.g. “1” for “playing unheard messages”, “2” for “playing saved messages” and so forth). The voice mailbox identifier and the password are typically multi-digits/characters, and are provided in response to voice prompts of the voice message service for such inputs.

Similarly, most consumers have accounts with banks, brokerage services, utilities, airlines and so forth, that offer the functions/features of allowing the consumers to call for the balances of the accounts, latest activities, and so forth. The process also typically involves the user calling the telephone number of a bank, a brokerage service, and so forth, providing an account number, providing a personal identification number (PIN), and then one or more menu selections (e.g. “1” for “current balance”, “2” for “last activity” and so forth). The account number and the PIN are also typically multi-digits/characters, and are provided in response to voice prompts for such inputs.

While speed dial, that is, re-dialing of a selected one of the most recently dialed numbers or dialing of a selected one of a list of pre-stored numbers of potential callees are widely available for wired or wireless telephony, little or no help have been provided in area of answering voice prompts.

Today, it is not unusual for a telephony user/consumer having multiple voice mailboxes, e.g. one for work, one for wireless mobile phone service, one for a land line phone service, and so forth, and numerous accounts with numerous services, e.g. one with a bank, one with a brokerage service, and so forth. As a result, it is not unusual for a telephony user/consumer to have to call some of these services numerous times in one day, e.g. the various voice mailboxes to check for messages, the brokerage services for stock prices and so forth. It is also not unusual for a telephony user/consumer to have to call some of these services occasionally, e.g. the telephony user/consumer's retirement account balance. Under the prior art, the user/consumer is required to remember all the voice mailbox/account identifiers and the passwords/PINs, regardless whether these information have to be frequently or infrequently recalled. Further, the appropriate information, once recalled, have to be re-entered with each use/call.

Thus, improved techniques where answers to the various frequently or infrequently encountered voice prompts may be provided efficiently, relieving the users/consumers the need to remember the various potential answers, and re-enter the applicable answers each time, are desired.

### SUMMARY OF SELECTED ASPECTS OF THE INVENTION

A communication apparatus, such as a telephone, is equipped to enable a user to quickly answer a voice prompt during a call with a callee, thereby relieving the need for the user to remember, and to re-enter the voice prompt answer for each use. More specifically, the communication apparatus is equipped to enable the user to select one of a number of pre-stored potential voice prompt answers, and send the current selected potential voice prompt answer as a voice prompt answer to a voice prompt of the callee of the current call.

In various embodiments, the speed answer to voice prompt may be repeated, allowing successive answers, e.g. a voice mailbox identifier, followed by a password, or an account identifier, followed by a PIN, to be conveniently and efficiently provided to the callee of the current call.

In one embodiment, the communication apparatus is equipped to automatically select another voice prompt answer as the current voice prompt answer, on sending of a current voice prompt answer to a callee.

In various embodiments, the communication apparatus is equipped to track its operational state, which includes, in one embodiment, a non-call-in-progress state and a call-in-progress state. Further, the communication apparatus is equipped to respond to a user input, in particular, a scroll and a dial/send input in a state dependent manner, depending on whether the communication apparatus is in the non-call-in-progress state or the call-in-progress state.

In one embodiment, in response to a scroll input, the communication apparatus scrolls a potential callee list and selects a current potential callee if the communication apparatus is in the non-call-in-progress state, and scrolls a potential voice prompt answer list and selects a current potential voice prompt answer if the communication apparatus is in the call-in-progress state.

In one embodiment, in response to a send/dial input, the communication apparatus calls the current potential callee if the communication apparatus is in the non-call-in-progress state, and sends the current potential voice prompt answer to the callee as a voice prompt answer to a voice prompt of the callee if the communication apparatus is in the call-in-progress state.

In one embodiment, the communication apparatus is equipped to automatically condition the communication apparatus to scroll the potential voice prompt answer list to select a current voice prompt, as soon as a call to a callee is placed.

In one embodiment, the communication apparatus is a wireless mobile phone; in another, the communication apparatus is a wired or cordless telephone handset. In yet other embodiments, the communication apparatus is a personal digital assistant incorporated with a telephony module, or a computing device incorporated with telephony facilities.

Additional aspects of the invention not summarized herewith are set forth in the detailed descriptions of various embodiments to follow.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a front view of a wireless mobile phone suitable for use to practice the present invention, in accordance with one embodiment;

FIG. 2 illustrates an internal component view of the wireless mobile phone of FIG. 1, in accordance with one embodiment;

FIG. 3 illustrates a potential callee list and a potential voice prompt answer list in further details, in accordance with one embodiment;

FIG. 4 illustrates the operational states of the wireless mobile phone of FIG. 1, in accordance with one embodiment;

FIG. 5 illustrates a method view of the present invention from a user perspective, in accordance with one embodiment;

FIG. 6 illustrates the operational flow of the relevant aspects of the operational logic of FIG. 2 in support of the speed voice prompt answer feature of the present invention, in accordance with one embodiment;

FIGS. 7a-7c illustrate typing of voice prompt answers, and their displays, in accordance with a number of embodiments; and

FIGS. 8a-8b illustrate additional potential callee and/or voice prompt answer lists in further details, in accordance with other embodiments.

### DETAILED DESCRIPTION OF EMBODIMENTS OF THE INVENTION

In the following description, various aspects of the present invention will be described referencing the illustrated embodiments. However, it will be apparent to those skilled in the art that the present invention may be practiced with alternate embodiments including only some or all aspects of the present invention.

For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention. The phrase “in one embodiment” will be used repeatedly, however the phrase does not necessarily refer to the same embodiment, although it may.

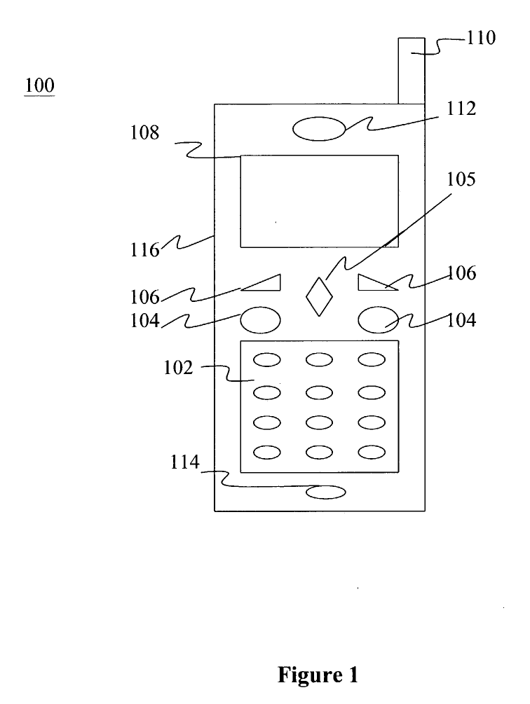

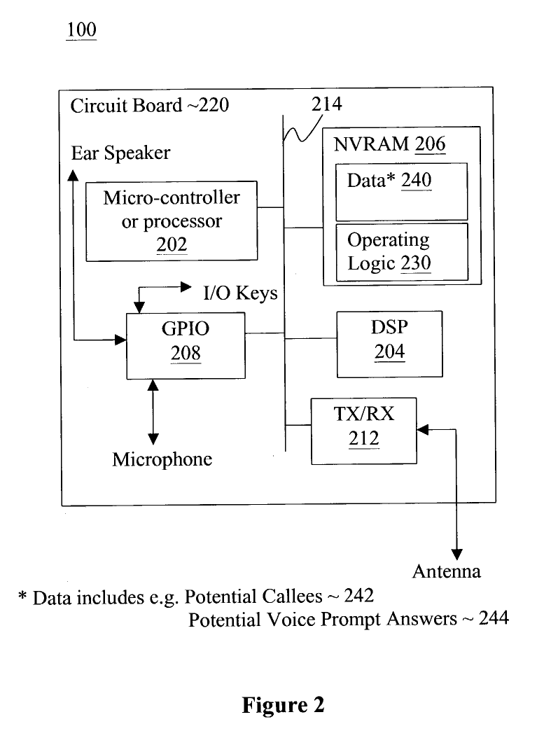

Referring now to FIGS. 1-2, wherein a front view and an internal component view of a wireless mobile phone 100 incorporated with the teachings of the present invention, in accordance with one embodiment, are shown. As will be described in more detail below, operating logic 230 of phone 100 is incorporated with the teachings of the present invention to allow a user to quickly provide answers to voice prompts, to enhance the usability and usage experience of phone 100. The enhancements include, but are not limited to, allowing a user to select one of a number of pre-stored potential voice prompt answers as a current selected potential voice prompt answer, and send the current selected potential voice prompt answer as a voice prompt answer to a voice prompt of a callee of a current call. In particular, in various embodiments, the enhancements further include the ability to track the operational state of phone 100, and responds to certain user inputs in a state dependent manner, to effectuate the above described selection and provision of voice prompt answers to voice prompts of a callee of a call.

For the embodiment of FIG. 1-2, phone 100 includes body casing 116, display 108, standard input key pad 102 having a number of conventional alphanumeric keys, “talk” and “end talk” buttons 104, scroll button 105, cursor control buttons 106, antenna 110, ear speaker 112, and microphone 114. Alphanumeric keys include in particular a number of special character keys, such as the “*” key and the “#” key (not explicitly identified). “Talk” button 104 is also referred to as the “dial/send” button.

Internally, wireless mobile phone 100 includes elements found in conventional wireless mobile phones, such as micro-controller/processor 202, digital signal processor (DSP) 204, non-volatile memory 206, general purpose input/output (GPIO) interface 208, and transmit/receive (TX/RX) 212 (also known as transceiver), coupled to each other via bus 214 and disposed on a circuit board 220.

Except for the enhancements provided to operating logic 230, and the employment of some of the enumerated elements in novel manners to practice the present invention, the enumerated elements otherwise perform their conventional functions known in the art.

In particular, scroll key 105 may be employed to scroll various menu options or selection lists, including in particular, but not limited to, a potential callee list with pre-stored potential callees and their phone numbers, and a potential voice prompt answer list with pre-stored potential voice prompt answers. For the embodiment, scroll key 105 may be selected in one of two positions, an “up” position or an “down” position for scrolling a selection list in an “up” direction and a “down” direction respectively. In alternate embodiments, separate “scroll” keys or scroll key with only a single scroll direction may be employed to scroll the potential callee and voice prompt answers lists instead. “Talk” button (aka “dial/send” button) 104 may be employed to initiate or place a call, e.g. to a current selected potential callee of the potential callee list, as well as sending, i.e. providing, a pre-stored voice prompt answer for a voice prompt of a callee. In alternate embodiments, separate “dial” and “send” keys may be employed to place a call to a callee and to send/provide a voice prompt answer to a voice prompt of the callee instead.

The alphanumeric keys may be employed to enter alphanumeric data, e.g. single digit/character answer to voice prompts, such as “1” for “playing unheard messages”, “2” for “playing saved messages”, “*” for “return to main menu” and so forth.

Cursor control buttons 106 may be employed to interact with various menu options and selection of list elements of various lists.

GPIO 208 may be employed to generate input signals, such as a “scroll” signal” (or more specifically, “scroll up” and “scroll down” signals) in response to a user selection of scroll key 105, a “dial/send” signal in response to a user selection of dial/send button 104 and so forth.

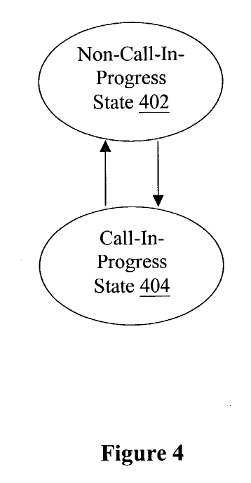

Operating logic 230, executed by processor 202 (with the assistance of DSP 204),-may be employed to operate phone 100, including in particular, tracking its operational state, which includes, in one embodiment, a non-call-in-progress state (402 of FIG. 4), and a call-in-progress state (404 of FIG. 4). In various embodiments, the non-call-in-progress and call-in-progress states are tracked by setting or unsetting a state data bit in a complementary manner. Accordingly, the current operational state of phone 100 is determined by examining the state data bit.

In alternate embodiments, the operational state of phone 100 may be tracked in other manners and/or with finer granularity, i.e. with more than the two enumerated non-call-in-progress and call-in-progress states. Determination of the current operational state of phone 100 may be adjusted accordingly.

Operating logic 230 may also be employed to respond to various input signals, including but are not limited to the earlier described “scroll” and “dial/send” signals, in an operational state dependent manner, in accordance with the present invention. Operating logic 230 may also be employed to generate the various signals to place a call to a callee and to provide a voice prompt answer for a voice prompt answer of the callee. In one embodiment, the voice prompts are sent/provided to the callee in dual tone multiple frequencies (DTMF) signals.

Beside employed to store operating logic 230, non-volatile memory 206 is also employed to store a number of working data, including but are not limited to the earlier mentioned pre-stored potential callee numbers and potential voice prompt answers. Pre-storing of potential callees and their numbers may be effectuated through any one of a number of techniques known in the art or to be designed. Similarly, pre-storing of potential voice prompt answers may be effectuated in like manner.

TX/RX 212 may be employed to transmit and receive signals. TX/RX 212 may support one or more of any of the known signaling protocols, including but are not limited to CDMA, TDMA, GSM, and so forth.

Except for the enhancements to operating logic 230, the constitutions of these elements are known, and will not be further described. As to operating logic 230, it may be implemented in the assembly or machine instructions of processor 202, or a high level language that can be compiled into these assembly or machine languages.

Accordingly, except for the enhancements provided, phone 100 otherwise represents a broad range of wireless mobile phones, including both the analog as well as the digital types (of all signaling protocols), uni-body as illustrated, as well as multi-portions, such as “flip phones”. Further, while the present invention will be described primarily referencing wireless mobile phone 100 of FIG. 1, the present invention is not so limited. The present invention may be practiced with wired or cordless telephone handsets. The present invention may also be practiced with personal digital assistants incorporated with telephony modules, or computing devices, such as laptop or desktop computers, incorporated with telephony facilities. These devices are all within the anticipated scopes of the present invention.

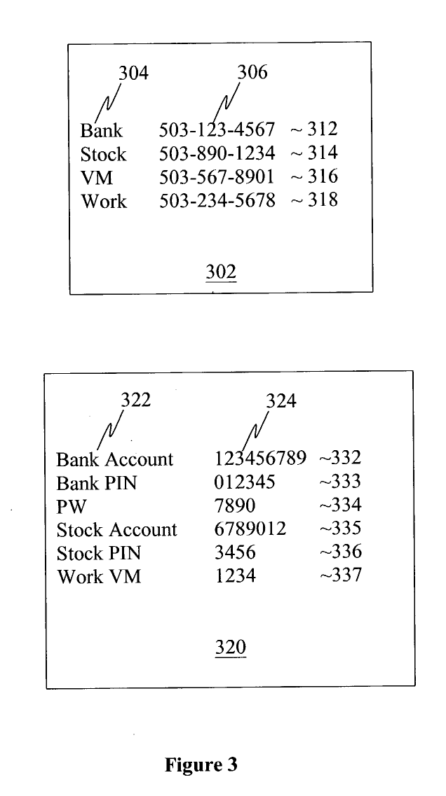

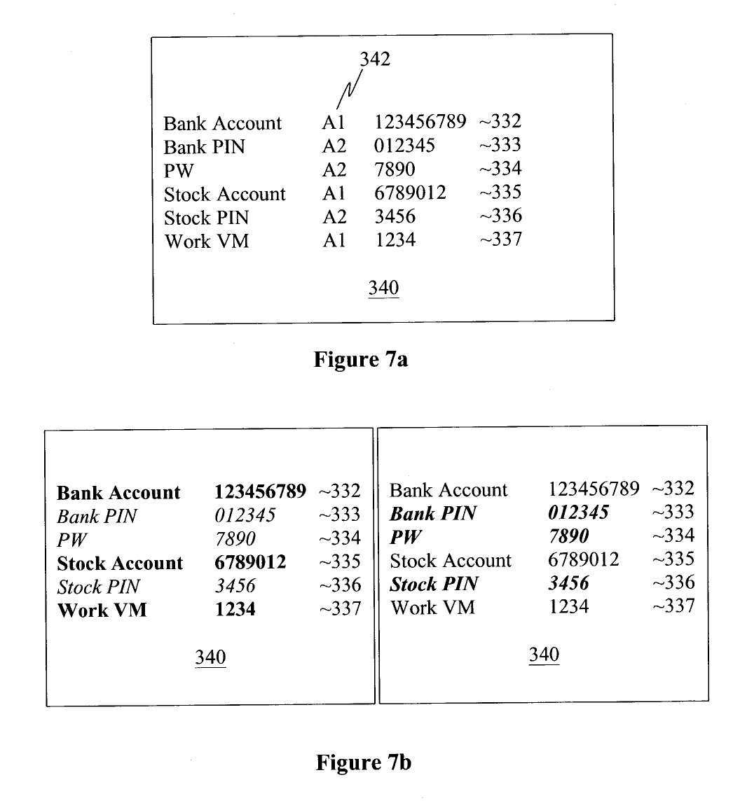

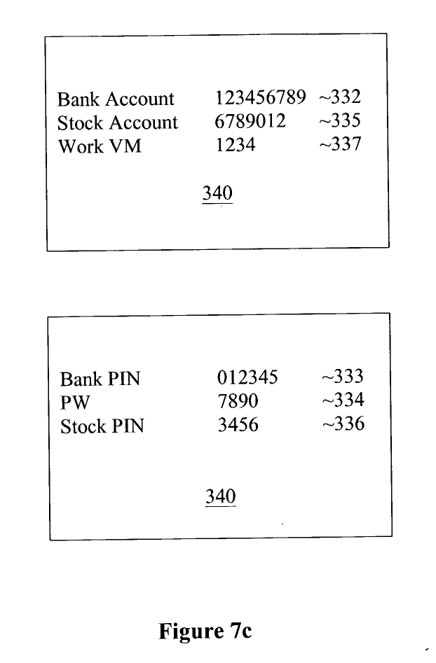

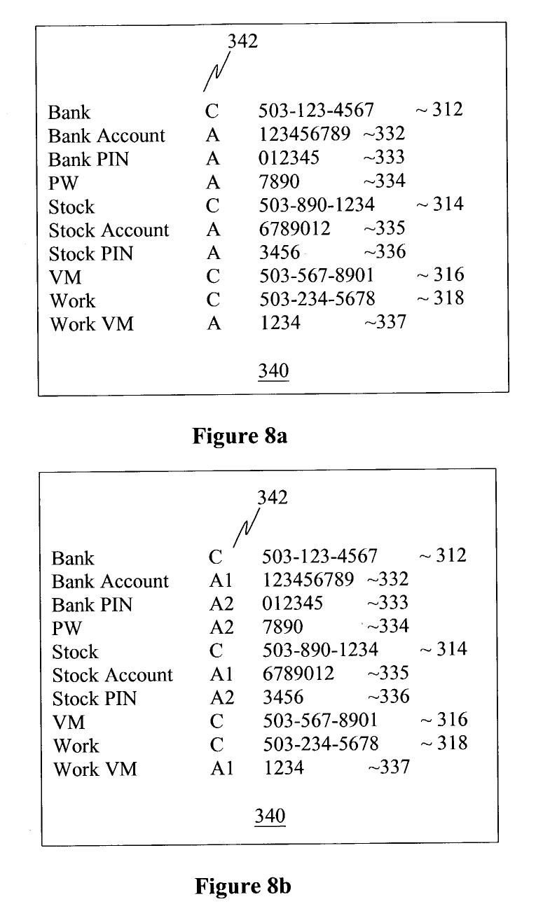

FIG. 3 illustrates the potential callee data and the potential voice prompt answers of FIG. 2 in further details, in accordance with one embodiment. For the embodiment, the data are stored as well as presented as separate lists. However, as will be further described in more details below, with references to FIG. 7a-7c, in alternate embodiments, the potential voice prompt answers may be stored together, but presented together or separately instead. Similarly, as will be further described in more details below, with references to FIG. 8a-8b, in alternate embodiments, the potential callee data and the potential voice prompt answers may be stored together, but presented together or separately instead.

For the embodiment of FIG. 3, potential callee list 302 comprises a number of potential callees 304 and their phone numbers 306. For examples, potential callees 304 of particular interest may include the user's bank and brokerage service phone numbers 312-314 for inquiring about the balances, the latest activities, and so forth of the respective accounts, and the user's personal as well as work voice message services' phone numbers 316-318 for retrieving voice messages left by callers unable to reach the user at the respective numbers. In alternate embodiments, potential callee list 302 may include other potential callees instead or in addition to the ones illustrated.

Still referring to FIG. 3, for the embodiment, potential voice prompt answer list 320 comprises a number of potential voice prompt answers 326 to potential voice prompts of callees 324. For examples, potential voice prompts 324 of particular interest may include the account identifiers, PINs, and so forth for the user's bank and brokerage service accounts 332-333 and 335-336 for the earlier described inquiring of balances, latest activities and so forth of the respective accounts, and the user's work voice mailbox identifier and password 337 and 338 for the earlier described retrieval of voice messages left by callers unable to reach the user at the respective numbers.

Note that for the embodiment, no voice mailbox identifier for the user's personal (non-work) voice message service is stored, as often such identifier is not additionally prompted when a user calls into his/her carrier service to retrieve voice messages or voice mails. For the purpose of the present application, the two terms, voice messages and voice mails are synonymous. Further, for the embodiment, a common password is stored, which may be used for both retrieving voice messages from the user's personal as well as we work voice message services. Of course, in alternate embodiments, potential voice prompt answer list 320 may include a voice mailbox identifier and a password for each voice message service, and other potential voice prompt answers instead or in addition to the ones illustrated.

Additionally, for the illustrated embodiment, the potential callees and the potential voice prompt answers are presented in an ascending order alphabetically, in alternate embodiments, the potential callees and the potential voice prompt answers may be stored and/or presented in any order. Preferably, the order is user configurable, and such configuration may be effectuated via any one of a number of customization techniques known in the art or to be designed.

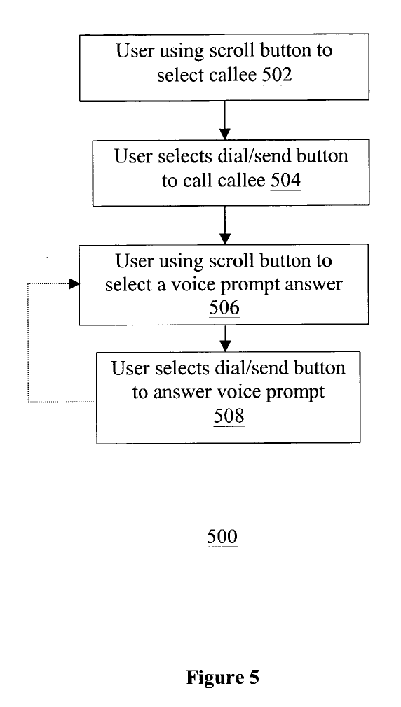

FIG. 5 illustrates a method view of the present invention, from the user perspective, in accordance with one embodiment. As illustrated, at block 502, a user may first employ scroll button 105 to scroll the potential callee list and select one of the potential callees to have a call placed. At block 504, the user may employ dial/send button 104 to actually place the call to the selected callee.

Assuming the call to the callee results in one or more voice prompts from the callee (as in the case where the callee is a voice message service), then, advantageously under the present invention, at block 506, the user may further employ scroll button 105 to scroll the potential voice prompt answers to select one of the potential voice prompts (e.g. a voice mailbox identifier) to be provided to the callee as the voice prompt answer to the voice prompt of the callee. At block 508, the user may again employ dial/send button 104 to actually send the current selected voice prompt answer to the callee of the current call prompting for the input.

Advantageously, under the present invention, blocks 506-508 may be repeated additional times to provide additional voice prompt answers to voice prompts of the callee. For example, upon first providing a voice mailbox identifier or an account identifier for a first voice prompt of the callee, blocks 506-508 may be repeated to provide a password or a PIN for a second voice prompt of the callee, as appropriate.

Accordingly, under the present invention, the user may be relieved of the need to memorize the various voice prompt answers and/or re-entering them during each use.

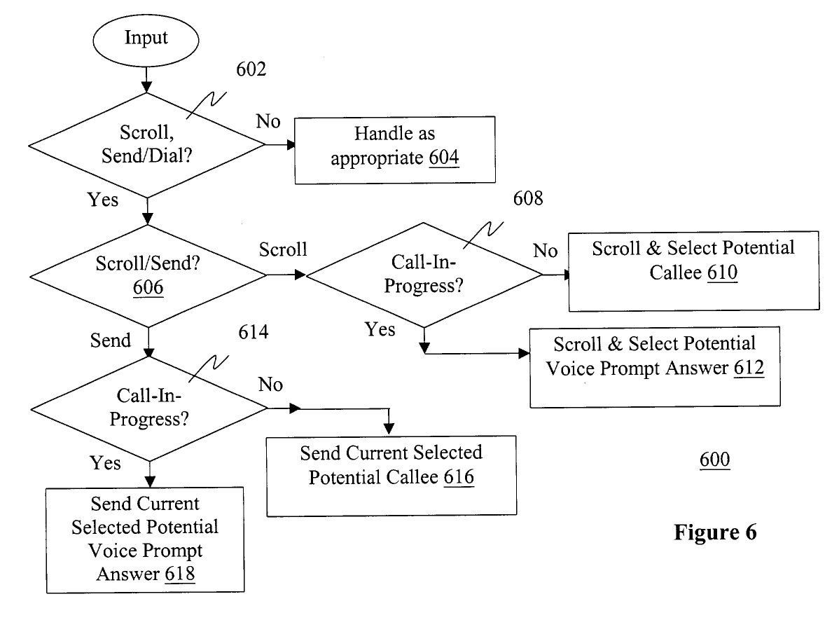

FIG. 6 illustrates the operational flow of the relevant aspects of operating logic 230 of FIG. 2, in accordance with one embodiment. As illustrated, for the embodiment, on receipt of a user input, such as a “scroll” input or a “dial/send” input (as denoted by the responsive signals generated e.g. by GPIO 208 in response to the selection of the corresponding key/button), operating logic 230 first determines the nature of the user input, block 602, i.e. whether it is a “scroll” input or a “dial/send” input, or other inputs that are to be handled in a state dependent manner, depending on whether phone 100 is in the non-call-in-progress state or the call-in-progress state.

For ease of understanding, the remaining description will assume “scroll” and “dial/send” inputs are the only two user inputs that are to be handled in an operational state dependent manner, hereinafter, simply state dependent manner. Clearly, those skilled in the art would appreciate that the present invention is not so limited. Other user inputs may be responded to in the state dependent manner similar to the state dependent response to be described below for the “scroll” and “dial/send” inputs.

Continuing to refer to FIG. 6, if the user input is an user input other than the “scroll” and “dial/send” inputs (which require state dependent response), the user input may be handled in any one of a number of application dependent manner, block 604, which is not relevant to the practice of the present invention. Thus, unless relevant to the understanding of the present invention, the operations of block 604 will not be further described.

However, if at block 602, it is determined that the user input is one of the “scroll” and “dial/send” inputs, operating logic 230 further determines whether the user input is the “scroll” input or the “dial/send” input, to facilitate invocation of different code segments to handle the different inputs.

In each case, that is regardless of whether the input is determined to be a “scroll” input or a “dial/send” input, operating logic 230 further determines the operational state of phone 100, blocks 608 and 614. As described earlier, in one embodiment, the determination is made by examining a state data bit that gets set or unset in a complementary manner to denote the current operational state.

At block 608, if it is determined that phone 100 is in the non-call-in-progress state, operating logic 230 scrolls the potential callee list by one callee, selects the next potential callee as the current potential callee to have a call placed, and presents the potential callee list reflecting the scrolling and selection, block 610. For example, the current selected potential callee may be “highlighted” in any one of a number of highlighting techniques, bold faced, reverse video and so forth. However, if it is determined that phone 100 is in the call-in-progress state, operating logic 230 scrolls the potential voice prompt answer list by one voice prompt answer, selects the next potential voice prompt answer as the current potential voice prompt answer to be sent, and presents the potential voice prompt answer list reflecting the scrolling and selection, block 612.

At block 614, if it is determined that phone 100 is in the non-call-in-progress state, operating logic 230 places a call to the current selected potential callee, and changes the operational state of phone 100 to the call-in-progress state, block 616. However, if it is determined that phone 100 is in the call-in-progress state, operating logic 230 sends the current selected potential voice prompt answer as the voice prompt answer to the voice prompt of the callee, block 618.

Additionally, in one embodiment, if the potential voice prompt answer list is being maintained, upon placing a call to the current selected callee, operating logic 230 automatically presents the potential voice prompt answer list and conditioned phone 100 ready for user selection of the presented potential voice prompt answers.

Similarly, in one embodiment, upon sending the current selected potential voice prompt answer as a voice prompt answer to a voice prompt of the callee of the current call, operating logic 230 automatically selects a next potential voice prompt answer as the current potential voice prompt answer, thus further improving the usability for the user. For example, if the user has pre-stored a “Work Voice Mail” identifier and a “Work Voice Mail” password, and assuming the two are stored and/or presented adjacent to each other (e.g. by virtue of an ordered presentation), the “Work Voice Mail” password is automatically selected as the next potential voice prompt answer, on sending of the “Work Voice Mail” identifier as a voice prompt answer to a voice prompt of the callee of the current call.

Back at block 604, one of the user inputs that is not handled in a state dependent manner is an “end call” input. On receipt of such user input, operating logic 230 terminates the current call. Further, operating logic 230 places phone 100 in the non-call-in-progress state.

Referring now to FIGS. 7a-7c, wherein as described earlier, in alternate embodiments, the potential voice prompt answers may be stored together, but presented either together or separately. As illustrated in FIG. 7a, the potential voice prompt answers, while being stored together, may be typed as voice prompt answers typically provided to a first voice prompt (A1) or voice prompt answers typically provided after the first voice prompt (A2).

Resultantly, as illustrated in FIG. 7b, voice prompt answers with type Al, while being presented together with voice prompt answers with type A2, may be highlighted (e.g. via bold face) when the voice prompt answers are first being scrolled after a call has been placed to a callee, and the voice prompt answers with type A2, may be highlighted (e.g. via bold face) when the voice prompt answers are being scrolled after a first voice prompt answer has been sent for a call.

Alternatively, as illustrated in FIG. 7b, employing the typing information, voice prompt answers of types A1 and A2 may be presented for selection separately, with voice prompt answers of type A1 being presented for selection, when the voice prompt answers are first being scrolled after a call has been placed to a callee, and the voice prompt answers of type A2 being presented for selection, when the voice prompt answers are being scrolled after a first voice prompt answer has been sent for a call.

Thus, the term “potential voice prompt answer list”, as used herein and in the claims, includes “potential voice prompt answer list” having potential voice prompt answers to be provided as voice prompt answers to first voice prompts of callees, potential voice prompt answers to be provided as voice prompt answers to voice prompts of callees that are after the first voice prompts of the callees or both.

Referring now to FIGS. 8a-8b, wherein as described earlier, in alternate embodiments, the potential callees and potential voice prompt answers may be stored together, but presented either together or separately. As illustrated in FIG. 8a, the potential callees and the potential voice prompt answers, while being stored together, may be typed as potential callees (C) and potential voice prompt answers (A) accordingly. Alternatively, as illustrated in FIG. 8b, the potential voice prompt answers may be further typed as being typically provided to a first voice prompt (A1) or typically provided after the first voice prompt (A2).

Once typed, the typing information may be employed to present the potential callees and the potential voice prompts answers together or separately, as earlier described for voice prompt answers only with references to FIGS. 7a-7c.

Thus, the terms “potential callee list” and “potential voice prompt answer list”, as used herein and in the claims, include “potential callee list” and “potential voice prompt answer list” that are separate lists as well as “potential callee list” and “potential voice prompt answer list” that are different portions of a combined “potential callee and voice prompt answer list”.

In conclusion, a method and apparatus enabling a communication apparatus user to quickly provide voice prompt answer to a voice prompt of a callee of a current call has been described. As suggested earlier, while the present invention has been described in terms of the above-illustrated embodiments, those skilled in the art will recognize that the invention is not limited to the embodiments described. The present invention can be practiced with modification and alteration within the spirit and scope of the appended claims. In particular, the present invention, with minor modifications that are well within the ability of those ordinarily skilled in the art, may be practiced on wired or cordless telephone handsets. Likewise, the present invention may be practiced on personal digital assistants incorporated with telephony modules or computing devices, such as laptop or desktop computers, incorporated with telephony facilities. Thus, the description is to be regarded as illustrative instead of restrictive on the present invention.

What is claimed is:

1. In a telephone having at least a non-call-in-progress state and a call-in-progress state, a method of operation, comprising:
while in said non-call-in-progress state,
scrolling a potential callee list and selecting a current potential callee, in response to each receipt of first one or more user inputs to scroll,
calling the current potential callee in response to receipt of a dial input, with the current potential callee becoming a current callee of a current call, and
placing the telephone in said call-in-progress state; and
while in said call-in-progress state,
scrolling a potential voice prompt answer list and selecting a current potential voice prompt answer, in response to each receipt of second one or more user inputs to scroll, and
sending the current potential voice prompt answer to the callee as a first voice prompt answer to a first voice prompt of the callee, in response to receipt of a first send input.

2. The method of claim 1, wherein the method further comprises automatically switching from the potential callee list to the potential voice prompt answer list.

3. The method of claim 1, wherein the method further comprises,
while the telephone continues to be in said call-in-progress state,
scrolling the potential voice prompt answer list and selecting a current potential voice prompt answer, in response to each receipt of third one or more user inputs to scroll, and
sending the current potential voice prompt answer to the callee as a second voice prompt answer to a second voice prompt of the calle, in response to receipt of a second send input.

4. The method of claim 3, wherein the potential voice prompt answer list comprises one or more potential voice prompt answers, including one or more of a voice mail box identifier, an account identifier, a user identifier, a password, and a personal identification number.

5. The method of claim 1, wherein the method further comprises,
while the telephone continuing to be in said call-in-progress state, engaging in said call with said callee,
automatically selecting another potential voice prompt answer as the current potential voice prompt answer, upon sending the previous current potential voice prompt answer to the callee as the first voice prompt answer to the first voice prompt of the callee; and
sending the current potential voice prompt answer to the callee, as a second voice prompt answer to a second voice prompt of the callee, in response to receipt of a second send input.

6. A telephony apparatus comprising:
storage medium having stored therein a plurality of programming instructions designed to operate the telephony apparatus to enable the telephony apparatus to operate in a state dependent manner, including a non-call-in-progress state and a call-in-progress state,
while the telephony apparatus in said non-call-in-progress state,
scrolling a potential callee list and selecting a current potential callee, in response to each receipt of first one or more user inputs to scroll,
calling the current potential callee, with the current potential callee becoming a current callee, and
placing the telephony apparatus in said call-in-progress state, and
while the telephony apparatus in said call-in-progress state,
scrolling a potential voice prompt answer list and selecting a current potential voice prompt answer, in response to each receipt of second one or more user inputs to scroll, and
sending the current potential voice prompt answer to the callee as a first voice prompt answer to a first voice prompt of the callee, in response to receipt of a first send input; and
a processor coupled to the storage medium to execute the programming instructions.

7. The telephony apparatus of claim 6, wherein the programming instructions further enable the telephony apparatus to automatically switch from the potential callee list to the potential voice prompt answer list.

8. The telephony apparatus of claim 6, wherein the programming instructions further enable the telephony apparatus, while the telephony apparatus continues to be in said call-in-progress state, to
scroll the potential voice prompt answer list and select a current potential voice prompt answer, in response to each receipt of third one or more user inputs to scroll, and
send the current voice prompt answer to the callee as a second voice prompt answer to a second voice prompt answer of the callee, in response to receipt of a second send input.

9. The telephony apparatus of claim 8, wherein the voice prompt answer list comprises one or more voice prompt answers including one or more of a voice mail box identifier, an account identifier, a user identifier, a password and a personal identification number.

10. The telephony apparatus of claim 6, wherein the programming instructions further enable the telephony apparatus, while the telephony apparatus continues to be in said call-in-progress state, to
automatically select another potential voice prompt answer as the current potential voice prompt answer, upon the telephony apparatus sending the previous current voice prompt answer to the callee, and
send the current potential voice prompt answer to the callee as a second voice prompt answer to a second voice prompt of the callee, in response to receipt of a second send input.

11. In a communication apparatus having at least a non-call-in-progress state and a call-in-progress state, a method of operation, comprising:
while the communication apparatus is in the call-in-progress state during a call to a callee,
scrolling a first potential voice prompt answer list and selecting a current potential voice prompt answer, in response to each receipt of first one or more user inputs to scroll; and
sending the current voice prompt answer to the callee as a first voice prompt answer to a first voice prompt of the callee, in response to receipt of a first send input.

12. The method of claim 11, wherein the method further comprises determining whether the communication apparatus is in said non-call-in-progress state or said call-in-progress state, on receipt of each of said first one or more user inputs to scroll.

13. The method of claim 11, wherein the method further comprises generating a send signal in response to each user selection of a send button, and said receipt of the first send input comprises receipt of a first of the responsively generated send signals.

14. The method of claim 11, wherein the first potential voice prompt answer list comprises one or more potential voice prompt answers including one or more of a voice mail box identifier, an account identifier and a user identifier.

15. The method of claim 11, wherein the method further comprises,
while the communication apparatus is in the call-in-progress state during a call to a callee,
scrolling a second voice prompt answer list and selecting a current voice prompt answer, in response to each receipt of third one or more user inputs to scroll, and
sending the current voice prompt answer to the callee as a second voice prompt answer to a second voice prompt of the callee, in response to receipt of a second send input.

16. The method of claim 15, wherein the second potential voice prompt answer list comprises one or more potential voice prompt answers including one or more of a password and a personal identification number.

17. The method of claim 15, wherein the first and second potential voice prompt answer lists are the same potential voice prompt answer list.

18. The method of claim 17, wherein the potential voice prompt answer list comprises one or more potential voice prompt answers including one or more of a voice mail box identifier, an account identifier and a user identifier, and one or more of a password and a personal identification number.

19. The method of claim 17, wherein the method further comprises upon sending the current potential voice prompt answer to the callee, automatically selecting another potential voice prompt answer as the current potential voice prompt answer.

20. The method of claim 15, wherein the method further comprises sending the current potential voice prompt answer to the callee as a second voice prompt answer to a second voice prompt of the callee, in response to receipt of a second send input.

21. The method of claim 11, wherein the method further comprises,
while the communication apparatus is in said non-call-in-progress state,
scrolling a potential callee list and selecting a current callee, in response to each receipt of second one or more user inputs to scroll,
calling the current callee, as well as placing the communication apparatus in said call-in-progress state, in response to receipt of a dial input, and
placing the communication apparatus in said call-in-progress state.

22. The method of claim 21, wherein
the method further comprises placing the communication apparatus in said non-call-in-progress state by performing a selected one of setting and un-setting of a data bit, and
said placing of the communication apparatus in said call-in-progress state comprises a complementary selected one of setting and un-setting of the data bit.

23. The method of claim 21, wherein the method further comprises generating a scroll signal in response to each user selection of a scroll button, and each of said receipt of first and second one or more scroll inputs comprises receipt of one of said responsively generated scroll signals.

24. The method of claim 21, wherein the method further comprises
terminating the call in progress in response to receipt of an end call input; and
placing the communication apparatus in said non-call-in-progress state.

25. The method of claim 21, wherein said potential callee list and said first potential voice prompt answer list are different portions of a combined potential callee and voice prompt answer list.

26. A communication apparatus comprising:
storage medium having stored therein a plurality of programming instructions designed to enable the communication apparatus to selectively operate in one of at least a non-call-in-progress state and a call-in-progress state of operation, and while the communication apparatus operates in the call-in-progress state during a call to a callee,
scroll a first potential voice prompt answer list and select a current potential voice prompt answer, in response to each receipt of first one or more user inputs to scroll, and
send the current voice prompt answer to the callee as a first voice prompt answer to a first voice prompt of the callee, in response to receipt of a first send input; and
a processor coupled to the storage medium to execute the programming instructions.

27. The communication apparatus of claim 26, wherein the programming instructions further enable the communication apparatus to determine whether the communication apparatus is in said non-call-in-progress state or said call-in-progress state, on receipt of each of said first one or more user inputs to scroll.

28. The communication apparatus of claim 26, wherein the programming instructions further enable the communication apparatus to generate a send signal in response to each user selection of a send button, and said receipt of the first send input comprises receipt of a first of the responsively generated send signals.

29. The communication apparatus of claim 26, wherein the first potential voice prompt answer list comprises one or more potential voice prompt answers including one or more of a voice mail box identifier, an account identifier and a user identifier.

30. The communication apparatus of claim 26, wherein the programming instructions further enable the communication apparatus, while the communication apparatus is in the call-in-progress state during a call to a callee,
to scroll a second voice prompt answer list and select a current voice prompt answer, in response to each receipt of third one or more user inputs to scroll, and
to send the current voice prompt answer to the callee as a second voice prompt answer to a second voice prompt of the callee, in response to receipt of a second send input.

31. The communication apparatus of claim 30, wherein the second potential voice prompt answer list comprises one or more of a password and a personal identification number.

32. The communication apparatus of claim 30, wherein the first and second potential voice prompt answer lists are one of the same potential voice prompt answer list.

33. The communication apparatus of claim 32, wherein the potential voice prompt answer list comprises one or more potential voice prompt answers including one or more of a voice mail box identifier, an account identifier and a user identifier, and one or more of a password and a personal identification number.

34. The communication apparatus of claim 32, wherein the programming instructions further enable the communication apparatus, upon sending the current potential voice prompt answer to the callee, to automatically select another potential voice prompt answer as the current potential voice prompt answer.

35. The communication apparatus of claim 30, wherein the programming instructions further enable the communication apparatus to send the current potential voice prompt answer to the callee as a second voice prompt answer to a second voice prompt of the callee, in response to receipt of a second send input.

36. The communication apparatus of claim 26, wherein the programming instructions further enable the communication apparatus, while operating in said non-call-in-progress state,
to scroll a callee list and selecting a current callee, in response to each receipt of second one or more user inputs to scroll,
to call the current callee, as well as placing the communication apparatus in said call-in-progress state, in response to receipt of a dial input, and
to place the communication apparatus in said call-in-progress state.

37. The communication apparatus of claim 36, wherein
the programming instructions further enable the communication apparatus to place the communication apparatus in said non-call-in-progress state by performing a selected one of setting and un-setting of a data bit, and
said programming instructions place the communication apparatus in said call-in-progress state by performing a complementary selected one of setting and un-setting of the data bit.

38. The communication apparatus of claim 36, wherein the programming instructions further enable the communication apparatus to generate a scroll signal in response to each user selection of a scroll button, and each of said receipt of first and second one or more scroll inputs comprises receipt of one of said responsively generated scroll signals.

39. The communication apparatus of claim 36, wherein the programming instructions further enable the communication apparatus to
terminate the call in progress, in response to receipt of an end call input; and
place the communication apparatus in said non-call-in-progress state.

40. The communication apparatus of claim 36, wherein the potential callee list and the first potential voice prompt answer list are different portions of a combined potential callee and potential voice prompt answer list.

41. In a communication apparatus having at least a non-call-in-progress state and a call-in-progress state, a method of operation, comprising:
generating an input signal in response to a user selection of an input button;
determining whether the communication apparatus is in at least one of the call-in-progress and non-call-in-progress states;
responding to the receipt of the input signal in a state dependent manner, depending on the result of said determining.

42. The method of claim 41, wherein
the input button is a scroll button;
the input signal is a scroll signal; and
said responding comprises scrolling a potential callee list and selecting a current potential callee if the result of said determining indicates said communication apparatus is said non-call-in-progress state, and scrolling a potential voice prompt answer list and selecting a current potential voice prompt answer if the result of said determining indicates said communication apparatus is said call-in-progress state.

43. The method of claim 41, wherein
the input button is a send/dial button;
the input signal is a send/dial signal; and
said responding comprises calling a current potential callee if the result of said determining indicates said communication apparatus is said non-call-in-progress state, and sending a current potential voice prompt answer if the result of said determining indicates said communication apparatus is said call-in-progress state.

44. A communication apparatus comprising:
an input button;
an input/output interface coupled to the input button to generate an input signal in response to a user selection of the input button;
means for determining whether the communication apparatus is in one of a call-in-progress state or a non-call-in-progress state; and
means coupled to the input/output interface and the determination means for receiving and responding to the input signal in a state dependent manner, depending on the result of said determining.

45. The communication apparatus of claim 44, wherein
the input button is a scroll button;
the input signal is a scroll signal; and
said responding means responds by scrolling a potential callee list and selecting a current potential callee if the result of said determining indicates said communication apparatus is said non-call-in-progress state, and by scrolling a potential voice prompt answer list and selecting a current potential voice prompt answer if the result of said determining indicates said communication apparatus is said call-in-progress state.

46. The communication apparatus of claim 44, wherein
the input button is a send/dial button;
the input signal is a send/dial signal; and
said responding means responds by calling a current potential callee if the result of said determining indicates said communication apparatus is said non-call-in-progress state, and by sending a current potential voice prompt answer if the result of said determining indicates said communication apparatus is said call-in-progress state.

47. In a communication apparatus having at least a non-call-in-progress state, a method of operation, comprising:
calling a potential callee, selected as a current potential callee, in response to receipt of a dial input while the communication apparatus is operating in said non-call-in-progress state; and
upon performing said calling, automatically presenting a list of potential voice prompt answers for selection, to have a current selected one of the presented potential voice answers be provided as a voice prompt answer to a voice prompt of the callee.

48. The method of claim 47, wherein the potential callee list and the potential voice prompt answer list are different portions of a combined potential callee and potential voice prompt answer list.

49. The method of claim 47, wherein said list of potential voice prompt answers comprises one or more of a voice mail box identifier, an account identifier, and a user identifier.

50. A communication apparatus comprising:
storage medium to store a plurality of potential callees and a plurality potential voice prompt answers; and
means coupled to the storage medium to place a call to a current selected one of the potential callees, and upon calling the current selected potential callee, automatically presenting the potential voice prompt answers for selection to have a current selected one of the potential voice prompt answers be provide to the callee as a voice prompt answer to a voice prompt of the callee.

51. The apparatus of claim 50, wherein the potential callees and the potential voice prompt answers are different portions of a combined potential callee and potential voice prompt answer list.

52. The apparatus of claim 50, wherein said potential voice prompt answers comprise one or more of a voice mail box identifier, an account identifier, and a user identifier.

53. In a communication apparatus having at least a call-in-progress state, a method of operation, comprising:
sending a first potential voice prompt answer, selected as a current potential voice prompt answer, as a first voice prompt answer to first voice prompt of a callee, in response to receipt of a first send input while the communication apparatus is operating in said call-in-progress state during a call with the callee; and
upon performing said sending, automatically selecting a second potential voice prompt answer as the current potential voice prompt answer.

54. The method of claim 53, wherein the method further comprises sending the second potential voice prompt answer, selected as the current potential voice prompt answer, as a second voice prompt answer to second voice prompt of a callee, in response to receipt of a second send input while the communication apparatus continues to operate in said call-in-progress state during said call with the callee.

55. The method of claim 54, wherein
said first potential voice prompt answer comprises a selected one of a voice mail box identifier, an account identifier, and a user identifier; and
said second potential voice prompt answer comprises a selected one of a password and a personal identifier number.

56. A communication apparatus comprising:
storage medium to store a plurality of potential voice prompt answers;
means coupled to the storage medium to select a first of the potential voice prompt answers as a current potential voice prompt answer, in response to receipt of a first send input while the communication apparatus is operating in a call-in-progress state during a call with a callee, and on sending the current potential voice prompt to the callee as a voice prompt answer to a voice prompt of the callee, to automatically select a second of the potential voice prompt answers as the current potential voice prompt answer; and
means coupled to the storage medium to send the current potential voice prompt to the callee as a voice prompt answer to a voice prompt of the callee.

57. The communication apparatus of claim 56, wherein the programming instructions further enable the communication apparatus to send the second potential voice prompt answer, selected as the current potential voice prompt answer, as a second voice prompt answer to second voice prompt of a callee, in response to receipt of a second send input while the communication apparatus continues to operate in said call-in-progress state during said call with the callee.

58. The apparatus of claim 56, wherein
said first potential voice prompt answer comprises a selected one of a voice mail box identifier, an account identifier, and a user identifier; and
said second potential voice prompt answer comprises a selected one of a password and a personal identifier number.

59. In a communication apparatus, a method of operation, comprising:
scrolling a list of potential voice prompt answers, and selecting a potential voice prompt answer as a current selected voice prompt answer, in response to receipt of a scroll input; and
providing the current selected voice prompt answer as a voice prompt answer to a voice prompt of a callee of a current call, in response to receipt of a send input.

60. The method of claim 59, wherein said list of potential voice prompt answers comprises one or more of a voice mail box identifier, an account identifier, a user identifier.

61. The method of claim 59, wherein said list of potential voice prompt answers comprises one or more of a password and a personal identifier number.

62. A communication apparatus comprising:
storage medium having stored therein a plurality of potential voice prompt answers;
means coupled to the storage medium to send a current selected one of the potential voice prompt answers as a voice prompt answer to a voice prompt of a callee of a current call, in response to receipt of a first send input.

63. The communication apparatus of claim 62, wherein said potential voice prompt answers comprise one or more of a voice mail box identifier, an account identifier, and a user identifier.

64. The communication apparatus of claim 62, wherein said potential voice prompt answers comprise one or more of a password and a personal identifier number.
